(19) United States
(12) Patent Application Publication
(10) Pub. No.: US 2016/0252209 A1
(43) Pub. Date: Sep. 1, 2016

(54) OIL RING, OIL RING ASSEMBLY, AND ROTATING MACHINE

(71) Applicant: Siemens Industry, Inc., Alpharetta, GA (US)

(72) Inventors: Daniel Lasorso, Norwood, OH (US); Nicholas G. Lang, Cincinnati, OH (US); Ryan Edward Queen, Amelia, OH (US); Valentin Weiske, Passau (DE)

(21) Appl. No.: 15/053,138

(22) Filed: Feb. 25, 2016

Related U.S. Application Data
(60) Provisional application No. 62/121,240, filed on Feb. 26, 2015.

(51) Int. Cl. F16N 7/28; H02K 5/16; H02K 17/02; B05D 5/04

(52) U.S. Cl. CPC F16N 7/28; B05D 5/04; H02K 5/16; H02K 17/02

(57) ABSTRACT

An oil ring is disclosed that includes an annular ring body having an inner surface, an outer surface, and first and second side surfaces. At least a portion of one or more surfaces of the annular ring body is coated with a material that electrostatically repels lubricant such as lubricant that may be provided in a lubricant reservoir of an electrodynamic machine.

### CROSS-REFERENCE TO RELATED APPLICATION(S)

This application claims priority to U.S. Provisional Application No. 62/121,240 filed on Feb. 26, 2015, the content of which is incorporated herein in its entirety.

### FIELD OF THE DISCLOSURE

Aspects of the present disclosure generally relate to an oil ring, an oil ring assembly, and a rotating machine.

### BACKGROUND

An oil ring, also referred to as a ring oiler, is a type of oil-lubrication system for bearings that may be arranged in rotating machines such as, for example, electrodynamic machines. An oil ring typically includes a metal ring placed around a horizontal shaft adjacent to a bearing of a machine or engine. An oil sump containing oil may be provided underneath the shaft and the oil ring may be large enough to dip into the oil of the oil sump. As the shaft rotates, the oil ring is carried with the shaft, and as a result, may pick up some oil out of the oil sump and deposit the oil onto the shaft, for example. Oil deposited on the shaft may flow sideways along the shaft and lubricate the bearing or may flow directly onto the bearing.

Electrodynamic machines, such as for example horizontal shaft induction motors, include rotating shafts restrained by bearings. A bearing is a machine element that constrains relative motion and reduces friction between moving parts. Example types of bearings include, for example, rolling-element bearings, hydrodynamic bearings, hydrostatic bearings, and magnetic bearings. Hydrodynamic bearings, for example, can generate a self-sustaining pressurized lubricant liquid film interface between the bearing surface and the corresponding shaft journal. Lubricant forming the lubricant film needs to be refreshed to replace that which is inevitably squeezed out of the bearing/journal interface due to their relative rotation. Oil replenishment also conveniently transfers heat that is generated within the interface or by thermal gradient transfer between the surfaces away from the bearing to, for example, a sump. For brevity, lubricant will hereinafter be referred to as oil, which a commonly used industrial lubricant. However, it should be appreciated that the term lubricant may refer to any substance capable of reducing friction between surfaces in mutual contact.

Induction motors, or other electrodynamic machines, oftentimes employ oil ring lubricated hydrodynamic bearings to support and constrain the rotating shaft. The hydrodynamic bearings are often contained in a bearing block portion of a bearing housing mounted on both axial ends of the motor. The bearing housing in cooperation with the motor housing may form an oil sump having a maximum fluid fill level below the motor shaft and bearing, so that the shaft does not come in direct contact with the oil sump. The bearing may include one or more axially or laterally restrained annular oil rings that capture the motor shaft journal within its inner cylindrical surface. The oil ring may be in direct contact with the motor shaft journal at the ring's approximately 12 o'clock upper position. A lower portion of the oil ring proximal its 6 o'clock lower position may be dipped into the oil within the sump. The oil ring can include a grooved or otherwise textured surface to enhance friction contact with the shaft journal. Motor shaft rotation may impart oil ring rotation. As the oil ring rotates, the oil ring may pick up oil from the oil sump at its 6 o'clock position, carry and transport an oil film on its surface, and deposit the oil onto the bearing when the portion of the oil ring previously at the 6 o'clock position reaches its new 12 o'clock position in contact with the shaft journal.

An oil ring's oil transfer rate from the oil sump to the shaft journal bearing is a function of and proportional to shaft rotation speed. Under low RPM and high load conditions, an oil ring may not be able to maintain a desired oil transfer rate from the sump to the bearing. Conversely, under high RPM conditions, oil may be slung off the ring due to centrifugal forces before a sufficient quantity can reach the bearing during the rotational trip from sump to bearing. Furthermore, during operation of the electrodynamic machine, frictional losses occur due to a hydrodynamic resistance of the oil to the motion of the oil ring. Additionally, friction slows down the motion of the oil ring, thus limiting the rate at which the oil ring is able to deliver oil to the bearing. This problem has been addressed for example by changing the geometry of the oil ring to reduce friction.

### SUMMARY

In accordance with one or more example embodiments of the disclosure, an oil ring is disclosed that includes an annular ring body with an inner surface, an outer surface, and side surfaces. At least a portion of the inner surface, the outer surface, or one or more of the side surfaces includes a coating that includes a material which electrostatically repels lubricant present in a lubricant reservoir as the oil ring passes through the lubricant reservoir.

In accordance with one or more example embodiments of the disclosure, an oil ring assembly is disclosed that includes one or more oil rings disclosed herein. Further, in accordance with one or more example embodiments of the disclosure, a machine is disclosed that includes an oil ring assembly disclosed herein. The machine may be, for example, an induction machine.

In accordance with one or more example embodiments of the disclosure, a method is disclosed that includes determining a first positive charge affinity of a lubricant, determining a threshold value, determining a material having a second positive charge affinity that is within the threshold value of the first positive charge affinity, and forming a coating of the material on at least a portion of at least one of an outer surface, an inner surface, a first side surface, or a second side surface of an annular ring body of an oil ring.

### BRIEF DESCRIPTION OF THE DRAWINGS

FIG. 1 shows a schematic perspective view of a bearing lubrication system that may include an oil ring or oil ring assembly in accordance with one or more example embodiments of the disclosure. The bearing lubrication system is shown as being incorporated in an example induction motor, with the motor shown in phantom.

FIG. 2 is a partial, axial, cross-sectional view of the bearing lubrication system of FIG. 1.

FIG. 3 is a partial, radial, cross-sectional view of the bearing lubrication system of FIG. 1.

FIG. 4 is a schematic view of an induction motor incorporating the bearing lubrication system of FIG. 1, showing the motor in a pitched position about the shaft axis relative to the horizontal position of FIG. 1.

FIG. 5 is a schematic view of an oil ring in accordance with one or more example embodiments of the disclosure.

### DETAILED DESCRIPTION

To facilitate an understanding of embodiments, principles, and features of the present disclosure, such embodiments, principles, and features are explained hereinafter with reference to implementation in illustrative embodiments. In particular, such embodiments, principles, and features are described in connection with an oil ring or oil ring assembly for machines or engines such as, for example, electrodynamic machines including electric motors or generators, or more specifically, induction motors. Embodiments of the present disclosure, however, are not limited to use in the described methods or system.

The components and materials described hereinafter in connection with various example embodiments are intended to be illustrative and not restrictive. Many suitable components and materials that would perform the same or a similar function as the materials described herein are intended to be encompassed within the scope of embodiments of the present disclosure.

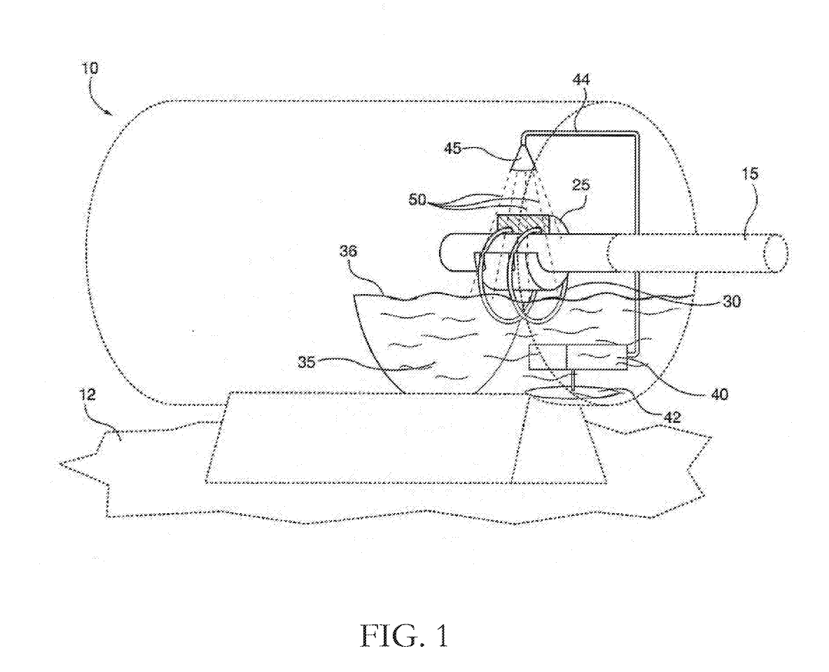

FIG. 1 shows a schematic perspective view of a bearing lubrication system that may include an oil ring or oil ring assembly in accordance with one or more example embodiments of the disclosure. The bearing lubrication system is shown as being incorporated in an example induction motor 10, with the motor 10 shown in phantom, mounted on a deck surface 12. The deck surface 12 may be stationary, and may be, for example and without limitation, mounted to a factory building floor or in a moving object. The moving object may be, for example and without limitation, a marine vessel, a railroad locomotive, a construction crane, or a mining drag line. As illustrated, the motor 10 is shown in phantom line drawing, because its electrodynamic components may be of conventional construction. The motor 10 includes a rotating shaft 15 that converts electrical energy to rotating mechanical energy.

The motor shaft 15 is supported by a bearing 25 such as, for example, a hydrodynamic bearing. FIG. 1 further shows a pair of annular oil rings 30. Each oil ring 30 can be in direct contact with the motor shaft 15, in particular a motor shaft journal at an approximately 12 o'clock upper position of each oil ring 30. A lower portion of each oil ring 30 (e.g., proximal an approximate 6 o'clock lower position of each oil ring 30) may be dipped into oil located in an internally defined oil sump 35 of the motor 10. A fill level 36 of the oil sump 35 is schematically depicted as being below the lower 6 o'clock surface of the rotating shaft 15 and bearing 25 so as not to whip or foam the oil, or cause unwanted rotating drag on the shaft 15. Rotation of the motor shaft 15 imparts rotation to the oil rings 30. As each oil ring 30 rotates from its previously dipped 6 o'clock position to a new 12 o'clock position in contact with the shaft journal, the oil ring 30 picks up oil from the oil sump 35 and carries and transports an oil film on a surface of the oil ring 30 for deposition into the bearing 25. The oil sump fill level 36 may flow to a horizontal level position under the influence of gravity, regardless of the relative orientation of the motor 10. If the motor 10 is installed in a moving object, such as a ship with a rolling deck, it is possible that at some rolling orientations the oil rings 30 may not be dipped into the internal oil sump 35.

In an example embodiment of the disclosure, a bearing lubrication system can provide a parallel oil delivery mechanism to the bearing 25 that is complementary to an oil delivery system comprising the oil rings 30. As FIG. 1 shows, the bearing lubrication system includes an oil sump pump 40 retained within the motor's internal oil sump 35. The sump pump 40 may be electric powered and have variable pumping capacity rates. Power for the pump 40 may be routed into the internal oil sump 35 through one of the existing fitting locations or a new aperture may be added in design revisions. The sump pump 40 includes an oil intake 42 in communication with oil retained in the oil sump 35. The pump intake 42 may be oriented in the sump 35 in a position likely to be below the oil fill line 36 under any or most foreseen motor orientations. The pump intake 42 can be mounted to the pump 40 with a two or three degree of motion swivel joint, so that the pump intake 42 remains plumb with and below the oil fill line 36 during pump motion when installed on a moving object. Alternatively, for motor applications in moving objects, the pump oil intake 42 may be constructed with a check valve upstream of a smaller reserve supply of oil retained in the intake 42 to account for situations in which the intake 42 loses continuous fluid communication with oil of the oil sump 35 by virtue of being above the sump oil fill line 36 during some transient orientations of the motor 10.

The sump pump 40 may generate a pressurized oil discharge that is routed through discharge line 44, the distal outlet of which is oriented proximal to the bearing 25, so that the discharge is directed to cause oil to directly contact or flow into the bearing 25 and shaft 15, in particular the shaft journal interface. The discharge line 44 may be constructed of any desired rigid or flexible pipe or tubing, and may be fixed to the motor 10, in particular to a housing of the motor 10, by any chosen fastener or bracket structure familiar to those skilled in the art. An oil nozzle 45 or other fluid spray pattern regulating component may be coupled to the distal end of the discharge line 44 to alter the oil discharge spray pattern of the oil spray 50. One skilled in the art may choose to substitute other components for the nozzle 45 such as, for example an orifice, a pulsed injector or aerator, or the like in order to achieve other desired oil spray patterns for a particular application.

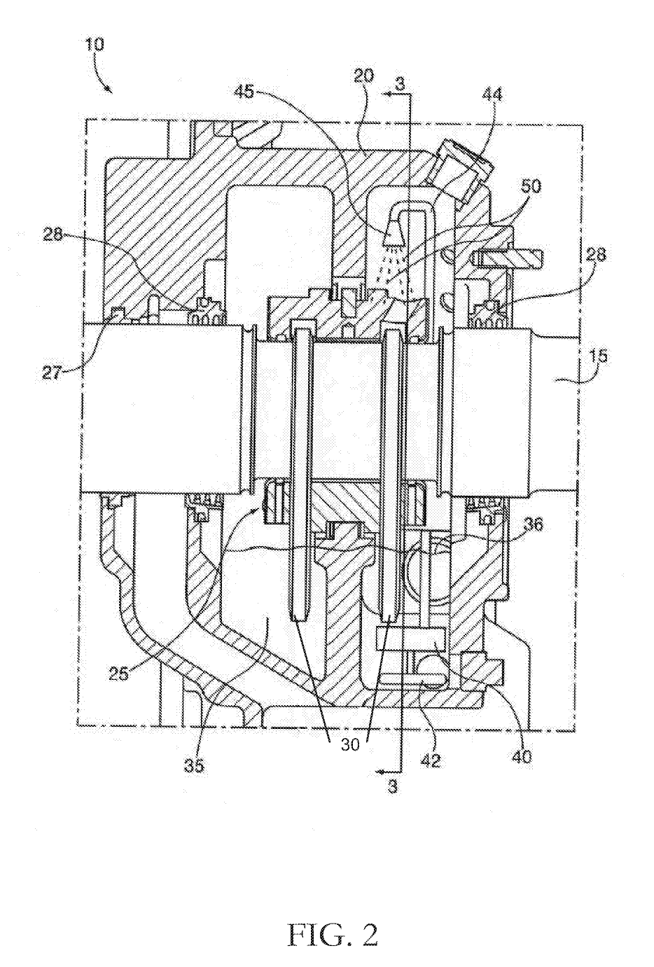

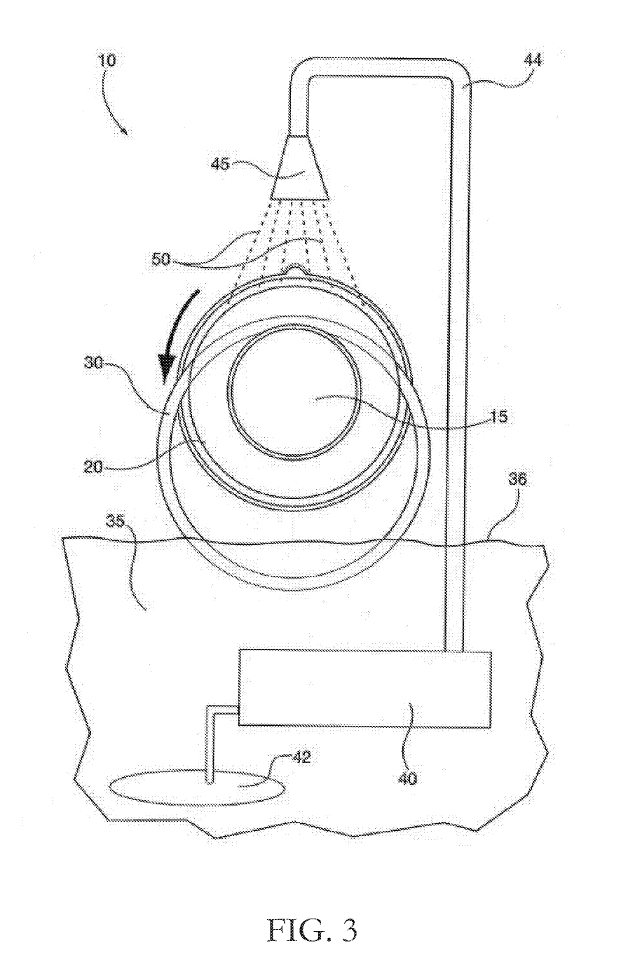

FIG. 2 is a partial, axial, cross-sectional view of the bearing lubrication system of FIG. 1, and FIG. 3 is a partial, radial, cross-sectional view of the bearing lubrication system of FIG. 1. As shown in FIGS. 2-3, the motor shaft 15 is retained in a bearing housing 20 that includes the bearing 25 and an air seal 27 which isolates oil, for example, from the electrodynamic components in an interior of the motor 10. A pair of elastomeric labyrinth seals 28 may flank the bearing 25 and corresponding journal surfaces of the shaft 15 to inhibit oil flow out of the bearing region axially along the shaft 15, and to retain a reserve of oil for replenishment of the oil film formed between the bearing 25 and corresponding journal surfaces. As described earlier in connection with FIG. 1, the oil rings 30, the oil sump 35 having fill level 36, the pump 40 with intake 42, the discharge line 44 with nozzle 45, and the oil spray 50 are also illustrated in FIGS. 2-3.

In operation, the parallel or auxiliary lubrication system enables reliable oil distribution under any motor load or speed operating conditions, regardless of whether the existing oil rings 30 are in fluid communication with oil in the motor's oil sump 35. The electric sump pump 40 oil flow rate may be selectively adjusted based on anticipated motor operating parameters of the motor 10 or in response to sensed operating conditions. In contrast to oil rings 30, which alone may not be able to deliver desired oil flow rates to the bearing 25 under low speed/high load or high speed operating conditions, the parallel electric sump pump 40 oil discharge flow rate through the pump nozzle 45 via the discharge line 44 may be adjusted as necessary to meet bearing operational needs. The sump pump 40 lubrication system assures reliable oil delivery to the bearings 25 when the motor 10 is operating in a moving vehicle, should the oil rings 30 lose contact with oil in the internal sump 35.

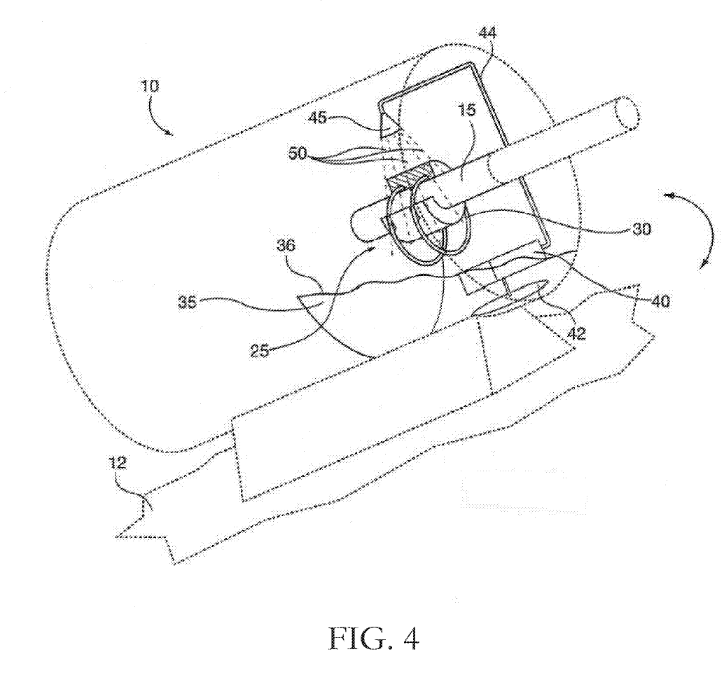

FIG. 4 is a schematic view of an induction motor incorporating the bearing lubrication system of FIG. 1, showing the motor in a pitched position about the shaft axis relative to the horizontal position of FIG. 1. In FIG. 4, the motor 10 is mounted on the deck 12, such as for example a ship deck. When the motor 10 is oriented horizontally, the sump oil fill line 36 is parallel with the deck 12 as shown in FIG. 1. On the contrary, as shown in FIG. 4, the deck 12 rolls and pitches, respectively, relative to X-Y-Z reference axes. As a result, the oil rings 30 may, at times, be above the oil fill line 36, and thus, may not be in continuous fluid communication with oil in the oil sump 35. In such situations, the lubrication system maintains oil spray 50 on the bearings 25, so that the bearings 25 receive a flow rate needed for desired operational performance.

In an example embodiment, the motor 10 is coupled to a motor drive controller via a communications pathway. The drive controller may be capable of altering the motor operating parameters, such as speed, torque, and responses to varying loads on the motor 10. The drive controller may also be capable of monitoring motor operating conditions such as stator winding current and temperature, oil sump temperature, etc. In another example embodiment, the electric oil sump motor 40 may be coupled to the motor drive controller so that the motor drive controller may vary the sump pump flow rate, pressure and, operating cycle (i.e., continuous, fluctuating, or intermittent operation) based on motor operating parameters or in response to sensed variations in motor operating parameters.

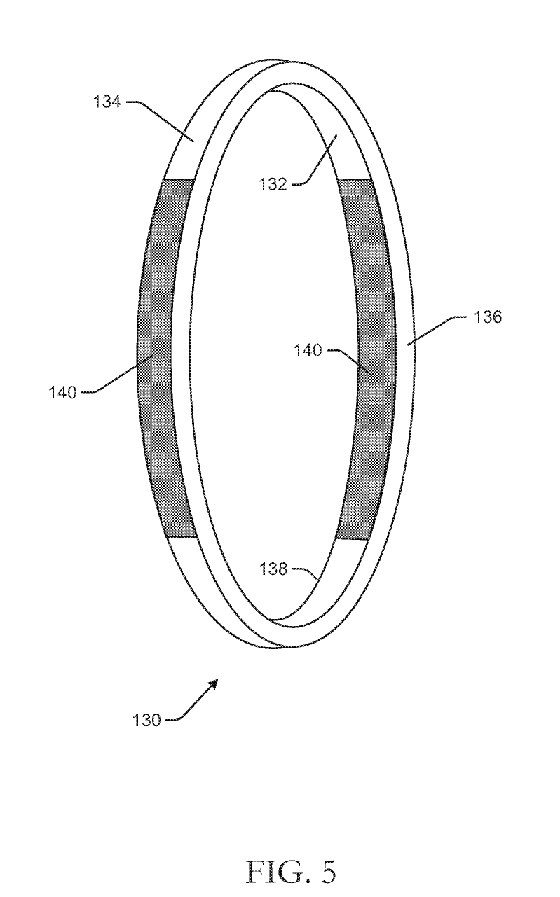

FIG. 5 is a schematic 3-dimensional view of an oil ring in accordance with one or more example embodiments of the disclosure. The oil ring 130 illustrated in FIG. 5 may be used in machines or engines such as, for example, electrodynamic machines, which may include, without limitation, electric motors or generators (e.g., induction motors, turbines, etc.) or any other suitable rotating machine. For example, the oil ring shown in FIG. 5 may be used in connection with the motor 10 depicted in FIGS. 1-4. In certain example embodiments, the oil ring 130 may be part of an oil ring assembly comprising a plurality of oil rings. In other example embodiments, the oil ring 130 may be the only oil ring arranged in the machine. The machine can comprise additional lubrication systems as described before.

The oil ring 130 can comprise metal. As described previously, during operation of an induction machine, for example, the oil ring 130 may dip into an oil sump underneath a shaft of the machine. As the shaft rotates, rotation may be imparted to the ring 130 such that the ring 130 picks up some oil out of the oil sump, and deposits the oil, for example, onto bearing(s) and/or the shaft of the machine. The oil of the oil sump may present a hydrodynamic resistance to the motion of the ring 130 that may result in frictional losses. More specifically, the oil ring 130 may encounter viscous frictional forces as it travels through the oil in the oil sump. Additionally, the friction may slow down the motion of the ring 130 thus limiting the rate at which the ring 130 is able to deliver oil to the bearing(s) and/or shaft.

The oil ring 130 comprises an inner surface 132, an outer surface 134, and side surfaces 136 and 138. The inner surface 132 is defined by the inner diameter of the oil ring 130 and the outer surface 134 is defined by the outer diameter of the ring 130. The inner surface 132 and the outer surface 134 are connected via the side surfaces 136 and 138. At least a portion of at least one of the surfaces 132-138 comprises a coating 140 that electrostatically repels the oil in the oil sump (reservoir) when the ring passes through the oil sump, thereby reducing the frictional force applied to the ring 130 as it travels through the oil in the oil sump. At least a portion or the outer surface 134, the inner surface 132, or side surfaces 136, 138 can comprise the coating 140. For example, in the example embodiment shown in FIG. 5, a portion of the outer surface 134 and a portion of the inner surface 132 comprise the coating 140. In an alternative embodiment, the coating 140 may be applied to all the surfaces 132-138 such that the oil ring 130 is completely covered by the coating 140. In those example embodiments in which an oil ring assembly comprising multiple oil rings 130 is provided, respective surfaces of two or more oil rings may be coated with different materials, each of which may be associated with a positive charge affinity value that is within a threshold value of a positive charge affinity value of a lubricant. Further, in certain example embodiments, a same surface of the oil ring 130 (e.g., the outer surface 134) may be coated at different portions with different materials, each of which may be associated with a positive charge affinity value that is within a threshold value of a positive charge affinity value of a lubricant.

The triboelectric effect (also known as triboelectric charging) is a type of contact electrification in which certain materials become electrically charged after they come into frictional contact with a different material. The triboelectric series lists materials in order of the polarity of charge separation when they come into contact with another object/material. The coating 140 of the oil ring 130 may comprise, for example, a material that is located close to machine oil (which is typically used as lubrication for rotating machines) in the triboelectric series, thus having similar electrostatic characteristics. The material used for the coating 140 may be, for example, Nylon or a material that is more strongly electro-positive such as, for example, Sorbothane®. According to the triboelectric series, machine oil comprises a positive charge affinity value of +29 nC/J, Nylon comprises a positive charge affinity value of +30 nC/J, and Sorbothane® comprises a positive charge affinity value of +58 nC/J. Since the machine oil and material used for the coating 140 are both associated with a positive charge affinity value, the oil and the coating material electrostatically repel one another as the oil ring 130 is in motion and passes through the oil in the oil sump. In certain example embodiments, a material may be chosen for the coating 140 that has a positive charge affinity value that is within a threshold value of a positive charge affinity value of the lubricant. One of ordinary skill in the art will appreciate that many other materials comprising a positive charge affinity value close to or even more positive to the positive charge affinity value of machine oil may be used.

In certain example embodiments, at least a portion of one or more of the surfaces 132-138 may comprise the coating 140 comprising an electrostatically positive material, while at least another portion of one or more of the surfaces 132-138 may comprise a coating comprising an electrostatically negative material that electrostatically attracts the lubricant. For example, at least a portion of the outer surface 134 may comprise a coating 140 of a material having a positive charge affinity and at least a portion of the inner surface 132 may comprise a coating of a material having a negative charge affinity. Electrostatic attraction or repulsion, depending on whether the material used in the coating has a positive or negative charge affinity, occurs due to local interactions between the oil and the coating. In the case of attraction, an electronegative surface coating wants to share an electron with the electropositive lubricant (e.g., machine oil) via a covalent bond. On the other hand, in the case of an electropositive surface coating, the similar electropositivities of the coating material and the lubricant eliminate the possibility for any electrostatic attraction between the lubricant and the coating, thereby reducing adhesion. This electrostatic repulsion between an electropositive coating material and the lubricant may be enhanced if the electropositive material also has a low surface energy. The simultaneous use of an electronegative coating and an electropositive coating may provide the dual technical effects of increased lubricant delivery from the oil ring to the shaft and/or bearing as well as reduced frictional drag forces on the oil ring 130 as it travels through the lubricant. Since electrostatic attraction and repulsion are both based on small-scale local interactions (e.g., interactions at a molecular level), a coating of an electronegative material provided in close proximity on the oil ring 130 to a coating of an electropositive material should not result in significant diminishment in the technical effects of providing either coating.

Such a coating 140 comprising a positive charge affinity the same as or similar to machine oil (or whatever lubricant may be used in the oil sump) such as, for example, Nylon or Sorbothane®, allows the oil ring 130 to operate at higher journal peripheral velocities before the oil ring 130 begins to skid, and also reduces the secondary hydrodynamic effect that causes the ring 130 to lift off the bearing journal. Conventional oil rings are ineffective at delivering a suitable amount of oil to the shaft and/or bearing at low rotational speeds, and are similarly ineffective a high rotational speeds due to the increase in the frictional drag forces as the oil ring travels through the oil. An oil ring 130 having the coating 140 in accordance with example embodiments of the disclosure extends the range of journal peripheral velocities at which the oil ring 130 is effective at delivering oil to the shaft and/or bearing by reducing the frictional drag forces and allowing the oil ring 130 to operate at higher rotational velocities. In addition, at higher journal peripheral velocities, an oil film may develop between an oil ring and the shaft, which may cause the ring to lift off the bearing journal due to the secondary hydrodynamic effect. The oil ring 130 having the coating 140 applied thereon may mitigate development of such an oil film by minimizing the frictional drag force as the ring 130 travels through the oil, and thus, may reduce the secondary hydrodynamic effect and allow the oil ring 130 to operate effectively at higher rotational speeds. These technical effects allow for operation of a self-lubricated bearing at higher rotational speeds and/or with larger bearing diameters (since larger bearing diameters imply larger shaft diameters, and thus, higher surface rotational speeds). The disclosed oil ring 130 and oil ring assembly reduces frictional losses and improves the bearing temperature performance in any rotating machine utilizing the oil ring 130.

While embodiments of the present disclosure have been disclosed in connection with illustrative examples, it will be apparent to those skilled in the art that many modifications, additions, and deletions can be made therein without departing from the spirit and scope of the disclosure and its equivalents, as set forth in the following claims.

What is claimed is:

1. An oil ring, comprising:
an annular ring body comprising an inner surface, an outer surface, a first side surface, and a second side surface; and
a coating applied to at least a portion of at least one of the inner surface, the outer surface, the first side surface, or the second side surface, wherein the coating comprises a material that electrostatically repels a lubricant.

2. The oil ring of claim 1, wherein the material electrostatically repels the lubricant as the oil ring travels through a lubricant reservoir containing the lubricant to cause a frictional drag force between the oil ring and the lubricant to be reduced.

3. The oil ring of claim 1, wherein the material is associated with a first positive charge affinity value that is within a threshold value of a second positive charge affinity value associated with the lubricant.

4. The oil ring of claim 1, wherein the material is associated with a first positive charge affinity value that is greater than a second positive charge affinity value associated with the lubricant.

5. The oil ring of claim 1, wherein the coating is applied to only a portion of the outer surface of the annular ring body.

6. The oil ring of claim 1, wherein the coating is applied at least a portion of the inner surface, the outer surface, the first side surface, and the second side surface.

7. The oil ring of claim 1, wherein the material is selected from a triboelectric series of materials.

8. The oil ring of claim 1, wherein the coating is a first coating and the material is a first material, the oil ring further comprising a second coating comprising a second material that electrostatically repels the lubricant.

9. The oil ring of claim 8, wherein the first coating is applied to a first portion of one of the outer surface, the inner surface, the first side surface, or the second side surface and the second coating is applied to a second portion of the one of the outer surface, the inner surface, the first side surface, or the second side surface.

10. The oil ring of claim 9, wherein the first material is associated with a first positive charge affinity value and the second material is associated with a second positive charge affinity value, and wherein each of the first positive charge affinity value and the second positive charge affinity value are within a threshold value of a third positive charge affinity value associated with the lubricant.

11. An oil ring assembly, comprising:
one or more oil rings, wherein each oil ring comprises:
a respective annular ring body comprising a respective inner surface, a respective outer surface, a respective first side surface, and a respective second side surface; and
a respective coating applied to at least a portion of at least one of the respective inner surface, the respective outer surface, the respective first side surface, or the respective second side surface, wherein the respective coating comprises a respective material that electrostatically repels a lubricant.

12. The oil ring assembly of claim 11, the one or more oil rings comprising a first oil ring and a second oil ring, wherein the first oil ring and the second oil ring are disposed axially around a rotatable shaft of a motor, and wherein the first oil ring and the second oil ring are separated by a distance in a longitudinal direction along the shaft.

13. The oil ring assembly of claim 11, the one or more oil rings comprising a first oil ring comprising a first coating and a second oil ring comprising a second coating, wherein the first coating comprises a first material and the second coating comprises a second material.

14. The oil ring assembly of claim 13, wherein the first material is associated with a first positive charge affinity that is different from a second positive charge affinity value associated with the second material.

15. The oil ring assembly of claim 14, wherein the first positive charge affinity value and the second positive charge affinity are each within a threshold value of a third positive charge affinity value associated with the lubricant.

16. A machine comprising the oil ring assembly of claim 11.

17. The machine of claim 16, wherein the machine is an induction motor.

18. A method, comprising:
determining a first charge affinity value associated with a lubricant;
determining a threshold value associated with the lubricant;
determining a material associated with a second charge affinity value that is within the threshold value of the first charge affinity value; and
applying a coating of the material to at least a portion of one or more surfaces of an oil ring.

19. The method of claim 18, wherein the coating is a first coating, the material is a first material, and the at least a portion of the one or more surfaces is a first portion, the method further comprising:
determining a second material associated with a third charge affinity value that is within the threshold value of the first charge affinity value; and
applying a second coating of the second material to a second portion of the one or more surfaces.

20. The method of claim 19, wherein each of the first material and the second material electrostatically repel the lubricant.
